(19) United States
(12) Patent Application Publication
(10) Pub. No.: US 2026/0071869 A1
(43) Pub. Date: Mar. 12, 2026

(54) METHOD FOR PRESELECTING AT LEAST ONE STEP PART OF AN ASSEMBLY MODULE

(71) Applicant: Liebherr-Aerospace Lindenberg GmbH, Lindenberg (DE)

(72) Inventors: Martin DÖHRING, Lindenberg (DE); Daniel ZIMMERMANN, Wangen (DE)

(21) Appl. No.: 19/323,267

(22) Filed: Sep. 9, 2025

(30) Foreign Application Priority Data
Sep. 12, 2024 (DE) 10 2024 126 235.4

(51) Int. Cl. G01B 21/02; B23P 19/10

(52) U.S. Cl. CPC G01B 21/02; B23P 19/10

(57) ABSTRACT

The disclosure relates to a method for preselecting at least one step part of an assembly module, comprising the steps of: measuring individual components which, in the mounted state together with at least one step part, create the assembly module, calculating a model of the assembly module using the dimensions obtained during the measurement of the individual components, and determining the dimensioning of the at least one step part on the basis of the calculated model and the allowable tolerances of the assembly module.

### CROSS REFERENCE TO RELATED APPLICATION

The present application claims priority to German Patent Application No. 10 2024 126 235.4 filed on Sep. 12, 2024. The entire contents of the above-listed application are hereby incorporated by reference for all purposes.

### TECHNICAL FIELD

The present disclosure relates to a method for preselecting at least one step part of an assembly module.

### BACKGROUND

In modern manufacturing, the precise alignment and assembly of individual components to form a complete assembly module plays a central role. A frequently used manufacturing method makes use of what are known as step parts, such as spacer washers, in order to align these individual components in the desired position relative to one another. These step parts are selected and installed according to empirical values, which facilitates the assembly process but is also associated with challenges.

### SUMMARY

The assembly process begins with bringing together the individual component to form a complete module. Subsequently, the dimensions and spacings within the module are carefully measured. If the measured spacings or dimensions of the assembly module or the individual components are outside the predetermined tolerances, it is necessary to disassemble the entire module. Thereafter, the step parts are replaced by differently dimensioned parts, such as thinner or thicker spacer washers, and the module is assembled and measured again. This iterative process is continued until the desired spacings and dimensions are achieved.

A significant disadvantage of this method is the high outlay associated with the repeated assembly and disassembly of the module. Each disassembly and re-assembly is furthermore associated with the risk of damaging the individual components. The documentation of the step parts used is a further problem. Owing to the frequent changes of the dimensions due to the iterative process, there is a high susceptibility to error, which can lead to lack of clarity and further errors in the manufacturing process and traceable documentation.

The aim of the present disclosure is to overcome or at least reduce the disadvantages set out above. This is achieved by a method as described herein.

The method according to the disclosure for preselecting at least one step part of an assembly module comprises the steps of:
measuring individual components which, in a mounted state together with at least one step part, create the assembly module,
calculating a model of the assembly module using the dimensions obtained during the measurement of the individual components, and
determining the dimensioning of the at least one step part on the basis of the calculated model and the allowable tolerances of the assembly module.

Thus, according thereto, before assembly of the individual components to form the assembly module, a measurement step is performed, in which each individual component is measured. A model of the assembly module is calculated on the basis of the result of the measurement, wherein the dimensions of the individual components obtained during the measurement are consulted for this purpose. Thus, a digital assembly module is created on the basis of the measured individual components, such that in a following step the dimensioning of the at least one step part can take place, with the aid of the calculated model. In this case, the dimensioning of the at least one step part is advantageously selected such that the assembly module calculated from the measured individual components is within predetermined tolerances.

Thus, unlike according to the conventional approach, it is no longer necessary to actually assemble the individual components to form the assembly module (and possibly to disassemble them if incorrectly dimensioned step parts have been used), in order to find out whether a correct dimensioning of the step parts has also been used here, since the calculation of the assembly module with the aid of the data of the individual components obtained from the measuring step already allows for a conclusion regarding the specific dimensioning of the at least one step part with which an assembly module that is within the tolerances can be obtained.

According to an advantageous development of the present disclosure, it can be provided that the method additionally comprises the step of assembling the assembly module with the measured individual components and the at least one step part, the dimension of which is specified.

Thus, not only the required dimensioning of the at least one step part is specified, but rather, depending on this identifying of the step part, also the assembly module is constructed, with the calculated dimensioning of the at least one step part.

According to an optional modification of the present disclosure, it can be provided that the method additionally comprises the step of storing the determined dimensioning and/or an identifier of the at least one step part in a file, optionally in a log file for documenting the parts used of the assembly module.

The automated storing of the dimensioning specified for the at least one step part or an identifier of the at least one step part used eliminates the error likelihood that typically occurs in the case of manual logging, and a construction of the assembly module based on empirical values. Finally, it is often the case here that an assembly module, once constructed, with a specified dimensioning of the at least one step part, has to be taken apart again and a differently dimensioned step part is used, such that errors often occur in the logging, regarding the type of step part that has now finally been used.

According to an advantageous embodiment of the present disclosure, it can be provided that the at least one step part can be selected in a plurality of dimensionings graduated relative to one another, and the at least one step part is selected in one of the gradations by determining the dimensioning.

The step part to be inserted into the assembly module can be used in a plurality of differently graduated dimensioning when joining together the plurality of individual components, wherein the relative spacings of the individual components may differ according to the selection of the dimensioning of the step part and depending on the tolerances of the individual components used. In order to now be able to react to the manufacturing tolerances of the respective individual components, it is often necessary to use a step part that is specifically dimensioned for this.

According to an optional modification of the present disclosure, it can be provided that the method additionally comprises the step of checking the dimensions of the calculated model for adherence to the tolerances of the assembly module, wherein in the case of non-adherence to the tolerances the individual components are checked and/or exchanged, and in the case of adherence to the tolerances the determination of the dimensioning of the at least one step part is continued with.

After the calculation of the assembly module, it is possible to check whether or not a calculated assembly module can also actually adhere to the predetermined tolerances. If the adherence to the tolerances is not possible due to the dimensions of the respectively measured individual components, this may lead to an exchange of one or more of the measured individual components. If it is possible, in contrast, to arrive, with the measured individual components, at an assembly module which is within the predetermined tolerance, the method is continued with and at least one step part suitable for this is calculated.

According to an advantageous modification of the present disclosure, it can be provided that the method additionally comprises the step of assembling the assembly module by joining together the individual components and the at least one step part, the dimensioning of which is determined.

Furthermore, it can be provided according to an advantageous development that the method additional comprises the step of selecting individual components which, in an assembled state together with at least one step part, create the assembly module, for measuring the respective individual components.

It is thus possible, for example, for a combination of individual components or a plurality of combinations of individual components to be determined depending on a plurality of calculated assembly modules, which individual component can in each case form, with respect to their actual dimensions and the available dimensionings of the step parts, assembly modules that are within the tolerances. In this case, optionally a combination of individual components and/or step parts is selected that is such that as far as possible no scrap or non-use of an individual component occurs. Thus, after a measurement of the respective individual components, a calculation is performed, such that the plurality of individual components can as far as possible all be used in an assembly module. Advantageously it is thereby possible to avoid a combination of individual components in an assembly module which would, without the performed calculation, lead to the predetermined tolerances of the assembly module being exceeded. In such a case, simply a correspondingly (smaller) dimensioned further individual component is combined with the individual component (dimensioned close to the upper acceptable tolerance range), such that upon joining together an assembly module results of which the tolerances are met.

According to a further development of the present disclosure, it can be provided that the method additionally comprises the step of listing the individual components to be measured that are required for creating the assembly module.

Thus, a parts carrier can be equipped on the basis of the listing, which parts carrier then measures the plurality of individual components inserted in the parts carrier, with the aid of an optical measuring unit. Since the assembly module may sometimes be complex modules, the listing of the individual components for equipping such a parts carrier is helpful.

According to a further optional modification of the present disclosure, it can be provided that the method further comprises measuring a plurality of individual components, wherein a subgroup of the plurality of individual components, in an assembled state together with at least one step part, creates the assembly module, optionally wherein the plurality of individual components is sufficient for creating a plurality of assembly modules.

It can thus be provided that a plurality of individual components is first measured, from which a plurality of assembly modules can be created. Different combinations of individual components for manufacturing an assembly module are then calculated, depending on the measurement results of the respective individual components. In this case, it can be provided that the plurality of combinations of individual components for manufacturing the plurality of assembly modules are selected such that as far as possible no assembly module is outside the predetermined tolerances. This results in little scrap of individual components and leads to a corresponding cost saving.

According to an optional modification of the present disclosure, it can be provided that after a measurement of the individual components a plurality of variants of assembly modules are calculated using different individual components, and those individual components are associated with a specific assembly module, in which the calculated model of the specific assembly module comes closest to a dimension specification.

Furthermore, it can be provided in this case that all possible variants of assembly modules are calculated on the basis of the measured individual components. Thus, all possible variations of individual components, which each result in an assembly module, are calculated, and a final association of the individual components to one another is determined depending on the results thus obtained.

According to a further optional modification of the present disclosure, it can be provided that the dimension specification is a tolerance range for the target dimensions of the assembly module and/or a desired dimensioning of the at least one step part, for example a particular thickness of a spacer washer.

Furthermore, according to an advantageous implementation of the present disclosure, it can be provided that the step part is a spacer element, for example a spacer washer.

In this case, it is known that a spacer element can be present in different gradations (or thicknesses), as a result of which, upon assembly of different individual components the respective tolerances of the individual components can be compensated, such that an assembly module is achieved of which the overall tolerance is as far as possible disconnected from the tolerance of a respective individual component.

According to a further optional modification of the present disclosure, it can be provided that the assembly module is an electrohydraulic servo valve, wherein optionally the individual components comprise at least one magnet, a lower pole piece and/or an upper pole piece.

Precisely in the case of an electrohydraulic servo valve (EHSV), which is for example used in aeronautical technology to precisely control the control surfaces of aircraft, such as ailerons, elevators and rudders, for example the tolerances in the region of the air gap between the magnet and rotor or between a and an armature are critical, and therefore the method explained above is particularly advantageous. This makes it possible to significantly increase the productive time of an EHSV and the quality in logging the actually installed constituents, and at the same time to reduce scrap of individual components.

According to a further modification of the present disclosure, it can be provided in this case that the allowable tolerances of the assembly module comprise or are an air gap between two individual components, in particular between a magnet and a rotor or an armature.

### BRIEF DESCRIPTION OF THE FIGURES

Further features, details and advantages of the disclosure are clear from the following description of the figures, in which:

FIG. 1: schematically show an implementation of the method according to the disclosure.

FIG. 2: shows a plurality of individual component during measurement by an optical measuring unit, and

FIG. 3 is a sectional view of an EHSV as an embodiment of an assembly module constructed from a plurality of individual components.

### DETAILED DESCRIPTION

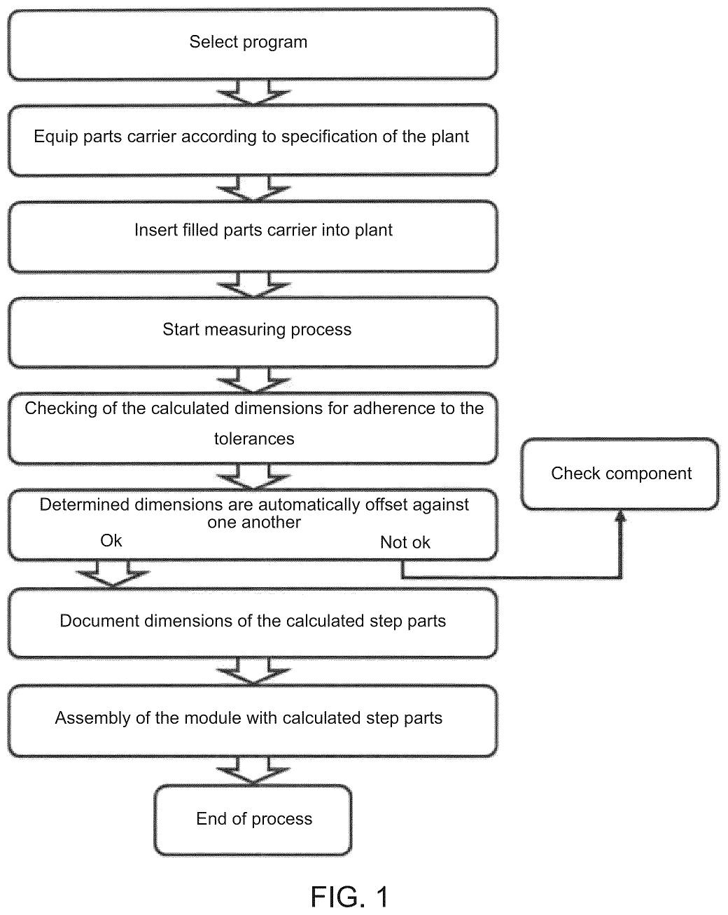

FIG. 1 shows a possible sequence of the method according to the disclosure, wherein after a selection of a specific program for an assembly module, a parts carrier is equipped according to the specifications of a plant carrying out the method. Thus, in this case, the required individual components are placed in a parts carrier, depending on the selected program for a certain assembly module, in which parts carrier the measurement of the dimensions of the respective individual components can also take place. The specification of which individual components are to be supplied to the measurement means that an incorrect deviation of the individual components required for the assembly module cannot occur.

Next, the parts carrier can then be inserted into the plant carrying out the method, wherein, however, this also includes the transfer of the individual components into a detection region of an optical measuring unit.

The method then starts, in that the individual components are each measured optically with regard to their dimensions. After obtaining the dimensions for each of the individual components to be measured, offsetting into a virtual assembly module then takes place, wherein the measured values of the respective individual components are consulted for the dimensions of the virtual assembly module. There is still a degree of freedom, in the calculation, with regard to the dimensioning of the at least one step part, wherein the dimensioning of the step part is selected such that the tolerances of the assembly module are not exceeded and not fallen below.

Subsequently, a check is made of the calculated dimensions of the assembly module with regard to adherence to and correctness of the tolerances. If the tolerances are exceeded, an error signal is output and a check or a replacement of the individual components takes place. In this case, the suitable dimensionings, in each case, of the step parts to be installed in the assembly module are selected such that exceeding or falling below the tolerances does not occur. In this case, a plurality of dimensionings of the step parts can be used, wherein the method is configured for using a dimensioning of a respective step part that is such that the tolerances of the assembly module are met.

If, in contrast, the check is successful, i.e. there is no exceeding or falling below the allowable tolerances in the calculated assembly module, for example with respect to a relative spacing between two individual components arranged in the assembly module or the outside dimensions of the assembly module, the method according to the disclosure is continued with.

Subsequently, documentation with regard to the dimensioning or the dimensions of the step parts used in the calculated model is then performed, such that a documentation of the installed components also with respect to the step parts used in the process is produced.

Finally, the at least one assembly module is them assembled with the calculated at least one step part and the individual components associated with a respective assembly module.

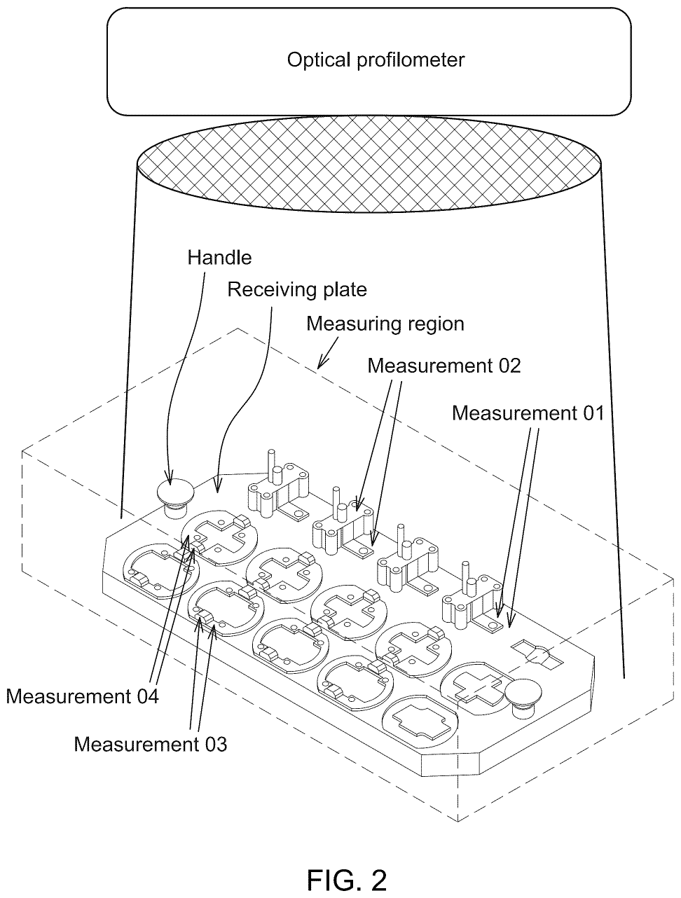

FIG. 2 shows a plurality of individual component during measurement by an optical measuring unit.

In the illustration, the optical measuring unit is designated an optical profilometer and is capable of determining the dimensions of the respective individual components arranged on a receiving plate. In this case, each of the individual components arranged on the receiving plate is measured separately. For easier insertion of the receiving plate into the optical profilometer, the receiving plate can have a handle or a plurality of handles.

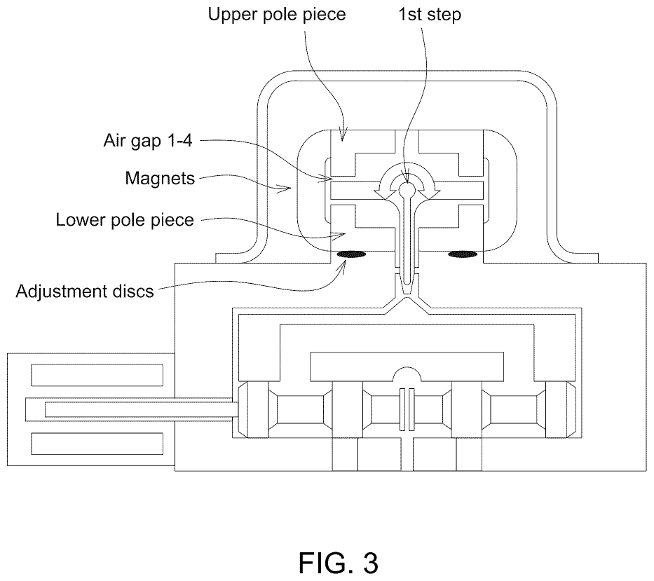

FIG. 3 is a sectional view of an EHSV (an electrohydraulic servo valve) as an example of an assembly module. It can be seen that the assembly module consists of a plurality of individual components which assume their respective position within the assembly module via step parts, for example adjustment discs. If, for example, the thickness of an adjustment disc (also spacer washer) is changed, then the corresponding air gap of a lower pole piece relative to an armature changes.

Due to the measurement of the individual components and the offsetting of the dimensions in the calculated assembly module, against one another, the correct dimensions of the step parts are incorporated straight away. Disassembly, as was previously conventional according to the method from the prior art, is therefore no longer necessary, since the erroneous use of incorrectly dimensioned step parts no longer occurs. Furthermore, a deviation of the tolerances in the offsetting of the individual components is identified before assembly, which prevents unnecessary work steps being performed. Furthermore, documentation of the step parts is performed automatically, and therefore transfer errors are excluded, which previously often arose on account of a frequently occurring change of the step parts. Not least, the method according to the disclosure increases the process reliability and reduces an assembly time.

1. Method for preselecting at least one step part of an assembly module, comprising the steps of:
measuring individual components which, in an assembled state together with at least one step part, create the assembly module,
calculating a model of the assembly module using the dimensions obtained during the measurement of the individual components, and
determining the dimensioning of the at least one step part on the basis of the calculated model and the allowable tolerances of the assembly module.

2. Method according to claim 1, further comprising the step of:
assembling the assembly module with the measured individual components and the at least one step part, the dimension of which is specified.

3. Method according to claim 1, further comprising the step of:
storing the determined dimensioning and/or an identifier of the at least one step part in a file, including in a log file for documenting the parts used of the assembly module.

4. Method according to claim 1, wherein the at least one step
part can be selected in a plurality of dimensionings graduated relative to one another, and the at least one step part is selected in one of the gradations.

5. Method according to claim 1, further comprising the step of:
checking the dimensions of the calculated model for adherence to the tolerances of the assembly module, wherein
in the case of non-adherence to the tolerances the individual components are checked and/or exchanged, and in the case of adherence to the tolerances the determination of the dimensioning of the at least one step part is continued with.

6. Method according to claim 1, further comprising the step of:
assembling the assembly module by joining together the individual component and the at least one step part, the dimensioning of which is determined.

7. Method according to claim 1, wherein before a
measurement of the individual components the following step is performed:
selecting individual components which, in an assembled state together with at least one step part, create the assembly module, for measuring the respective individual components.

8. Method according to claim 1, further comprising the step of:
listing the individual components to be measured that are required for creating the assembly module.

9. Method according to claim 1, further comprising the step of:
measuring a plurality of individual components, wherein a subgroup of the plurality of individual components, in an assembled state together with at least one step part, creates the assembly module, wherein
the plurality of individual components is sufficient for creating a plurality of assembly modules.

10. Method according to claim 9, wherein after a measurement of the
individual components a plurality of variants of assembly modules are calculated using different individual components, and those individual components are associated with a specific assembly module, in which the calculated model of the specific assembly module comes closest to a dimension specification.

11. Method according to claim 10, wherein all possible variants of
assembly modules are calculated on the basis of the measured individual components.

12. Method according to claim 10, wherein the
dimension specification is a tolerance range for the target dimensions of the assembly module and/or a dimensioning of the at least one step part.

13. Method according to claim 1, wherein the step part is a
spacer element, for example a spacer washer.

14. Method according to claim 1, wherein the assembly module
is an electrohydraulic servo valve, wherein the individual components comprise at least one magnet, a lower pole piece and/or an upper pole piece.

15. Method according to claim 1, wherein the allowable
tolerances of the assembly module comprise or are an air gap between two individual components, including between a magnet and a rotor or an armature.
